(19) United States
(12) Patent Application Publication
(10) Pub. No.: US 2011/0304740 A1
(43) Pub. Date: Dec. 15, 2011

(54) UNIVERSAL IMAGE CAPTURE MANAGER

(75) Inventor: Kevin M. Crucs, Copley, OH (US)

(73) Assignee: APTERYX, INC., Akron, OH (US)

(21) Appl. No.: 12/797,644

(22) Filed: Jun. 10, 2010

(51) Int. Cl. H04N 5/228

(52) U.S. Cl. 348/222.1; 348/E05.091

(57) ABSTRACT

A universal image capture manager (UICM) for facilitating the acquisition of image data from a plurality of image source devices (ISDs) to an image utilizing software application (IUSA). The UICM is implemented on a computer processing device and includes a first software communication interface configured to facilitate data communication between the UICM and an IUSA. The UICM also includes a translator/mapper (T/M) software component being in operative communication with the first software communication interface and configured to translate and map an image request from an IUSA to at least one device driver (DD) software component of a plurality of DD software components. The UICM further includes a plurality of DD software components being in operative communication with the T/M software component. Each of the DD software components is configured to facilitate data communication with at least one ISD.

### TECHNICAL FIELD

Certain embodiments of the present invention relate to image acquisition. More particularly, certain embodiments of the present invention relate to a user software application acquiring image data from a plurality of diverse image data source devices.

### BACKGROUND

Many times it is desirable to bring images into a user software application. This is often done in the context of a medical office environment or a hospital environment. Images may be captured by image source devices such as, for example, a digital camera device or an X-ray imaging device and are brought into a user software application such as, for example, an imaging software application or a practice management software application running on a personal computer or a workstation.

Each image source device may require a different interface and image data format for acquiring image data from that image source device. The various interfaces may be TWAIN-compatible or not, may be in the form of an application program interface (API), a data link library (DLL), or some other type of interface. Also, the various image data may be raw image data, DICOM image data, 16-bit or 32-bit or 64-bit image data, or some other type of image data, for example.

Therefore, the process of acquiring an image into a user software application can be difficult and cumbersome. For example, to acquire and place an image in a user software application, a user may have to first leave the software application, open a hardware driver, set the device options, acquire the image, save the image to a local storage area, close the hardware driver, return to the software application, locate the saved image, and read the image file from the local storage area. Hardware and software developers have developed proprietary interfaces to help solve this problem. However, having a large number of proprietary interfaces has resulted in software developers having to write a driver for each different device to be supported. Furthermore, this has also resulted in hardware device manufacturers having to write a different driver for each software application. General interoperability between user software applications and image source devices has been almost non-existent.

Further limitations and disadvantages of conventional, traditional, and proposed approaches will become apparent to one of skill in the art, through comparison of such systems and methods with the present invention as set forth in the remainder of the present application with reference to the drawings.

### SUMMARY

An embodiment of the present invention comprises a universal image capture manager (UICM) for facilitating the acquisition of image data from a plurality of image source devices (ISDs) to an image utilizing software application (IUSA). The UICM includes a computer processing device. The UICM further includes a first software communication interface implemented on the computer processing device and configured to facilitate data communication between the UICM and a IUSA. The UICM also includes a translator/mapper (T/M) software component implemented on the computer processing device, being in operative communication with the first software communication interface, and configured to translate and map an image request from an IUSA to at least one device driver (DD) software component of a plurality of device driver software components. The translator/mapper (T/M) software component may further be configured to translate and map image data received from at least one image source device (ISD) via at least one device driver (DD). The UICM further includes a plurality of device driver (DD) software components implemented on the computer processing device, being in operative communication with the T/M software component, wherein each of the plurality of DD software components is configured to facilitate data communication with at least on image source device (ISD). In accordance with an embodiment of the present invention, at least one of the plurality of device driver (DD) software components may be a TWAIN-compatible device driver provided by a manufacturer of at least one image source device (ISD). In accordance with an embodiment of the present invention, at least one of the plurality of device driver (DD) software components may be a non-TWAIN-compatible direct driver interface developed using a software development kit (SDK) provided by a manufacturer of at least one image source device (ISD). In accordance with an embodiment of the present invention, at least one of the plurality of device driver (DD) software components may be a non-TWAIN-compatible direct driver interface. In accordance with an embodiment of the present invention, at least one of the plurality of device driver (DD) software components may be an application program interface (API). In accordance with an embodiment of the present invention, at least one of the plurality of device driver (DD) software components may be part of a dynamic link library (DLL). The computer processing device may include one of a personal computer, a work station computer, and a server computer. In accordance with an embodiment of the present invention, the IUSA, capable of communicating with the UICM via the first software communication interface, is implemented on the computer processing device. The UICM may be configured to be able to add a device driver (DD) software component to the plurality of device driver (DD) software components. The UICM may be configured to be able to remove a device driver (DD) software component from the plurality of device driver (DD) software components. In accordance with an embodiment of the present invention, the first software communication interface is configured to facilitate data communication between the UICM and an IUSA through a computer network. The first software communication interface may be configured to facilitate data communication between the UICM and an IUSA through a computer-readable storage device. In accordance with an embodiment of the present invention, each of the plurality of DD software components is configured to facilitate data communication with at least one image source device (ISD) through a computer network.

Another embodiment of the present invention comprises a method of acquiring image data from any of multiple image source devices. The method includes receiving an image request message from an image utilizing software application (IUSA). The method further includes translating the image request message and mapping the image request message to at least one device driver (DD) software component of a plurality of device driver (DD) software components in response to the translating. The method also includes the at least one DD software component communicating with at least one corresponding image source device (ISD) or a plurality of image source devices to retrieve at least one set of image data from the at least one image source device (ISD) in response to the mapping. The method further includes returning the at least one set of image data to the IUSA. The method may further include reformatting the at least one set of image data before returning the at least one set of image data to the IUSA. Reformatting the at least one set of image data may include mapping the at least one set of image data, representative of multiple images, into a single composite image. Reformatting the at least one set of image data may include mapping the at least one set of image data, representative of multiple images from multiple image source devices, into a single composite image. Reformatting the at least one set of image data may include mapping the at least one set of image data, representative of multiple image slices from a single image source device, into a single composite image. The method step of receiving an image request message may be via at least one computer network. The method step of communicating with at least one image source device (ISD) may be via at least one computer network. The method step of returning the at least one set of image data may be via at least one computer network, in accordance with an embodiment of the present invention. The method step of returning the at least one set of image data may be via a computer-readable storage device, in accordance with an embodiment of the present invention. The at least one DD software component may be a TWAIN-compatible device driver provided by a manufacturer of at least one image source device (ISD), in accordance with an embodiment of the present invention. The at least one DD software component may be a non-TWAIN-compatible direct driver interface developed using a software development kit (SDK) provided by a manufacturer of at least one image source device (ISD), in accordance with an embodiment of the present invention. The at least one DD software component may be a non-TWAIN-compatible direct driver interface, in accordance with an embodiment of the present invention. The at least one DD software component may be an application program interface (API), in accordance with an embodiment of the present invention. The at least one DD software component may be part of a dynamic link library (DLL), in accordance with an embodiment of the present invention. The method may be implemented on a computer processing device, in accordance with an embodiment of the present invention.

A further embodiment of the present invention comprises a non-transitory computer-readable medium having a plurality of computer-executable instructions thereon for performing a method. The method includes receiving an image request message from an image utilizing software application (IUSA). The method further includes translating the image request message and mapping the image request message to at least one device driver (DD) software component of a plurality of device driver software components in response to the translating. The method also includes the at least one device driver (DD) software component communicating with at least one corresponding image source device (ISD) of a plurality of image source devices to retrieve at least one set of image data from the at least one ISD in response to the mapping. The method further includes returning the at least one set of image data to the IUSA. The method may also include reformatting the at least one set of image data before returning the at least one set of image data to the image utilizing software application (IUSA).

Another embodiment of the present application comprises a system for acquiring image data from multiple sources. The system includes an image utilizing software application (IUSA) implemented on a computer processing device. The system further includes a plurality of image source devices (ISDs). The system also includes a universal image capture manager (UICM) configured to operatively communicate with the IUSA and the plurality of image source devices to retrieve image data from at least one of the plurality of image source devices (ISDs) in response to a request from the IUSA. The UICM may be a software module implemented on the computer processing device on which the IUSA is implemented, in accordance with an embodiment of the present invention. The UICM may be a software module implemented on a computer processing device that is different from the computer processing device on which the IUSA is implemented, in accordance with an embodiment of the present invention. The system may further include a computer network operatively interfacing between the UICM and the plurality of ISDs, in accordance with an embodiment of the present invention. The system may also include a computer network operatively interfacing between the IUSA and the UICM, in accordance with an embodiment of the present invention. The system may include a computer network operatively interfacing between the IUSA, the UICM, and the plurality of ISDs, in accordance with an embodiment of the present invention. The system may further include a modality server operatively interfacing to the IUSA via a computer network, in accordance with an embodiment of the present invention. The system may also include a worklist PACS server operatively interfacing to the IUSA via a computer network, in accordance with an embodiment of the present invention.

A further embodiment of the present invention comprises an apparatus for acquiring image data from any of multiple image source devices. The apparatus includes means for receiving an image request message from an IUSA. The apparatus further includes means for translating the image request message. The apparatus also includes means for mapping the image request message to at least one image source device (ISD) of a plurality of image source devices in response to the translating. The apparatus further includes means for communicating with the at least one ISD to retrieve at least one set of image data from the at least one ISD in response to the mapping. The apparatus also includes means for returning the at least one set of image data to the IUSA.

These and other advantages and novel features of the present invention, as well as details of illustrated embodiments thereof, will be more fully understood from the following description and drawings.

### BRIEF DESCRIPTION OF THE DRAWINGS

FIG. 1 illustrates a block diagram of a first example embodiment of a system for acquiring image data from multiple sources;

FIG. 2 illustrates a block diagram of an embodiment of a universal image capture manager software module architecture used in the system of FIG. 1;

FIG. 3 illustrates a block diagram of a portion of the universal image capture manager software module architecture of FIG. 2 showing an image request configuration of an image acquisition process;

FIG. 4 illustrates a block diagram of a portion of the universal image capture manager software module architecture of FIG. 2 showing an image return configuration of an image acquisition process;

FIG. 5 is a flowchart of an embodiment of a method for acquiring image data from any of multiple image source devices using the system of FIG. 1;

FIG. 6 illustrates a block diagram of a second example embodiment of a system for acquiring image data from multiple sources;

FIG. 7 illustrates a block diagram of a third example embodiment of a system for acquiring image data from multiple sources;

FIG. 8 illustrates a block diagram of a fourth example embodiment of a system for acquiring image data from multiple sources; and

FIG. 9 illustrates a block diagram of a fifth example embodiment of a system for acquiring image data from multiple sources.

### DETAILED DESCRIPTION

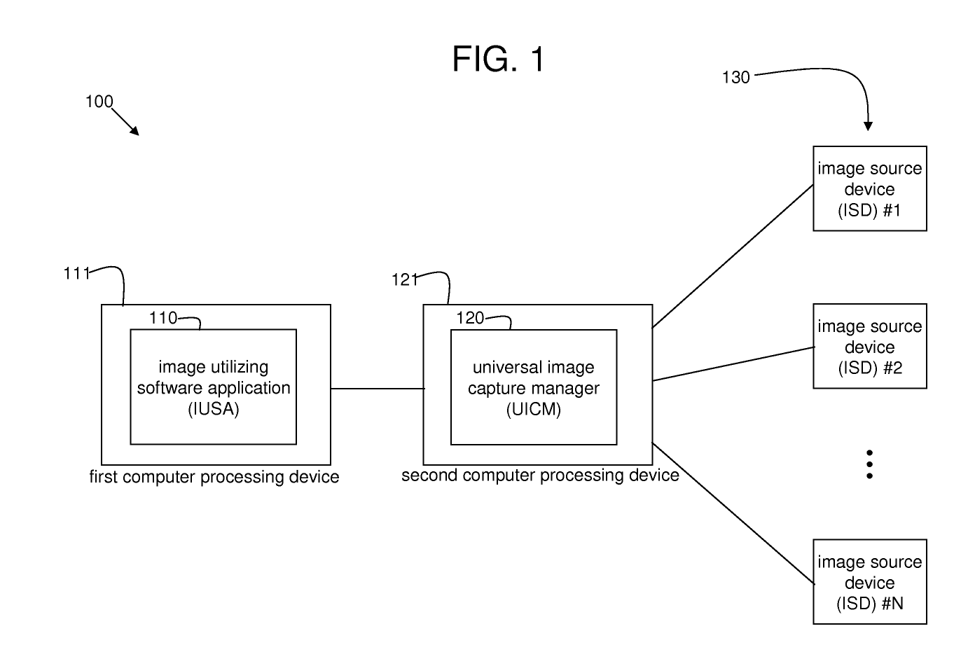

FIG. 1 illustrates a block diagram of a first example embodiment of a system 100 for acquiring image data from multiple sources. The system 100 includes an image utilizing software application (IUSA) 110 implemented on a first computer processing device 111, a universal image capture manager (UICM) 120 implemented on a second computer processing device 121, and a plurality of image source devices (ISDs) 130 (e.g., ISD #1 to ISD #N, where N represents a positive integer). The IUSA 110 may be a client software application such as an imaging software application or a practice management application as may be used, for example, in a physician's office, a dentist's office, or a hospital environment. The IUSA 110 is implemented on the first computer processing device 111, in accordance with an embodiment of the present invention, such as a personal computer (PC) or a work station computer, for example.

The plurality of ISDs 130 are hardware-based devices that are capable of capturing images in the form of image data (e.g., digital image data). Examples of such ISDs include a visible light intra-oral camera, an intra-oral X-ray sensor, a panoramic (pan) X-ray machine, a cephalometric (ceph) X-ray machine, a scanner for scanning photo-sensitive imaging plates, and a digital endoscope. There exist many types of ISDs using many different types of interfaces and protocols to export the image data from the ISDs.

The universal image capture manager (UICM) 120 is a software application or a software module. The second computer processing device 121, having the UICM 120, operatively interfaces between the first computer processing device 111, having the IUSA 110, and the plurality of ISDs 130, and acts as an intermediary between the IUSA 110 and the plurality of ISDs 130. In accordance with an embodiment of the present invention, the UICM 120 is a software module implemented on the second computer processing device 121 such as, for example, a personal computer (PC), a workstation computer, a server computer, or a dedicated processing device designed specifically for UICM operation.

The UICM 120 is configured to communicate in a single predefined manner with the IUSA 110 to receive image request messages from the IUSA 110 and to return image data to the IUSA 110. Furthermore, the UICM 120 is configured to acquire image data from the multiple image source devices (ISDs) 130. As a result, the IUSA 110 does not have to be concerned with being able to directly acquire image data from multiple different image data sources itself. Instead, the UICM 120 takes on the burden of communicating with the various ISDs 130 with their various communication interfaces and protocols.

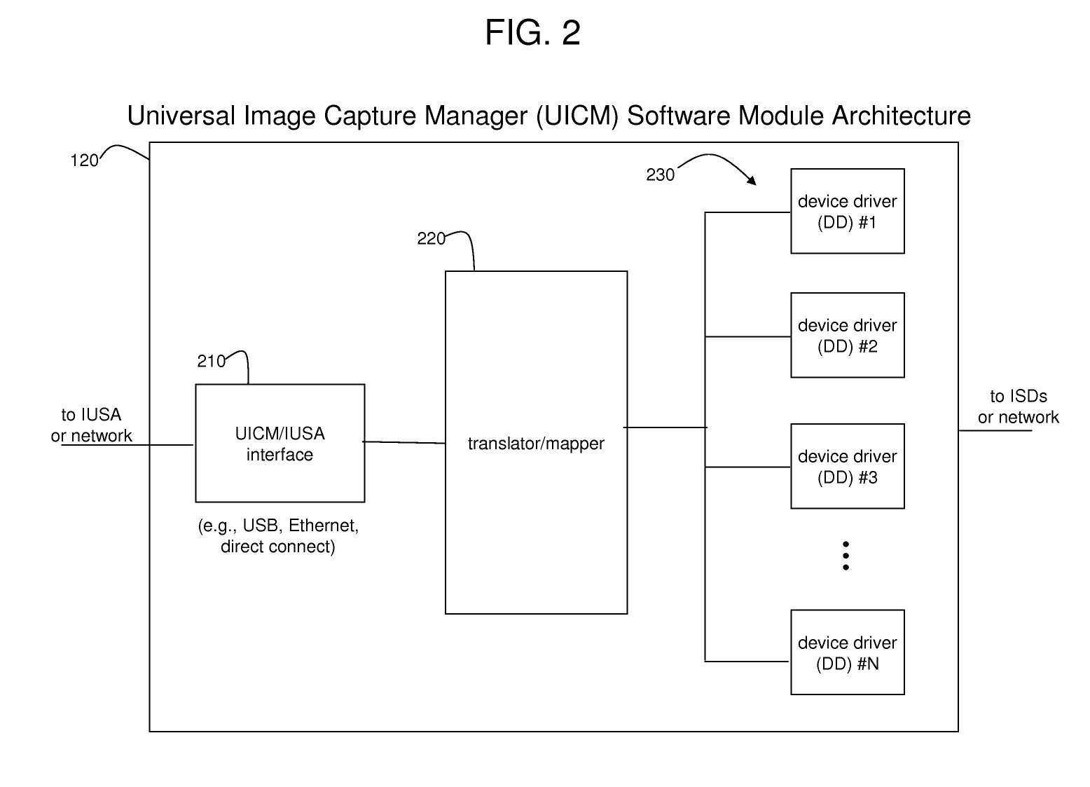

FIG. 2 illustrates a block diagram of an embodiment of a universal image capture manager (UICM) software module architecture used in the system 100 of FIG. 1. The UICM 120 includes a first software interface (UICM/IUSA interface) 210 configured to facilitate data communication between the UICM 120 and the IUSA 110. The interface 210 may be, for example, a USB interface, an Ethernet interface, or a proprietary direct connect interface. The interface 210 is implemented in software and operates with the hardware of the second computer processing device 121 to input and output data (e.g., image request message data and image data) from/to the IUSA 110.

The UICM 120 further includes a plurality of device drivers (DDs) 230 (e.g., DD #1 to DD #N, where N is a positive integer). The device drivers 230 are implemented as software components and operate with the hardware of the second computer processing device 121 to input and output data (e.g., image data and device driver access data) from/to the plurality of ISDs 130. Each of the device drivers 230 is configured to facilitate data communication with at least one of the image source devices (ISDs) 130.

A device driver (DD) of the plurality of device drivers 230 may be, for example, a TWAIN-compatible device driver provided by a manufacturer of at least one corresponding ISD. TWAIN is a well-known standard software protocol that regulates communication between software applications and image source devices (ISDs). TWAIN is not an official acronym but is widely known as “Technology Without An Interesting Name”.

Another device driver (DD) of the plurality of device drivers 230 may be, for example, a TWAIN-compatible or a non-TWAIN-compatible direct driver interface developed using a software development kit (SDK) provided by a manufacturer of at least one corresponding ISD. An SDK may include a compiler, libraries, documentation, example code, an integrated development environment, and a simulator for testing code.

A further device driver (DD) of the plurality of device drivers 230 may be, for example, a custom application program interface (API). An API is an interface implemented by a software program which enables interaction with other software. In accordance with an embodiment of the present invention, a device driver (DD) of the plurality of device drivers 230 may be part of a dynamic link library (DLL). A DDL is a library that contains code and data that may be used by more than one program at the same time and promotes code reuse and efficient memory usage.

The UICM 120 is configured to be able to readily add or remove a device driver (DD) software component to the plurality of device drivers 230. In accordance with an embodiment of the present invention, the UICM 120 is configured in a software “plug-n-play” manner such that device drivers may be readily added or removed without having to reconfigure any of the other device drivers. As a result, the UICM 120 may be easily adapted as image source devices 130 of the system 100 are added, changed out, upgraded, replaced, or discarded.

The UICM 120 also includes a translator/mapper (T/M) 220 software component. The T/M 220 is in operative communication with the UICM/IUSA interface 210 and the plurality of device drivers (DDs) 230. The T/M 220 is configured to translate and map an image request from the IUSA 110 to at least one device driver of the plurality of device drivers 230. Furthermore, the T/M 220 is configured to translate and map image data received from at least one image source device of the plurality of ISDs 130 via at least one device driver of the plurality of device drivers 230.

The computer-executable software instructions of the UCIM 120 may be stored on a non-transitory computer-readable medium, in accordance with an embodiment of the present invention. The non-transitory computer-readable medium may include, for example, a compact disk (CDROM), a digital versatile disk (DVD), a hard drive, a flash memory, an optical disk drive, random access memory (RAM), read only memory (ROM), electronically erasable programmable read only memory (EEPROM), magnetic storage devices such as magnetic tape or magnetic disk storage, or any other medium that can be used to encode information that may be accessed by a computer processing device.

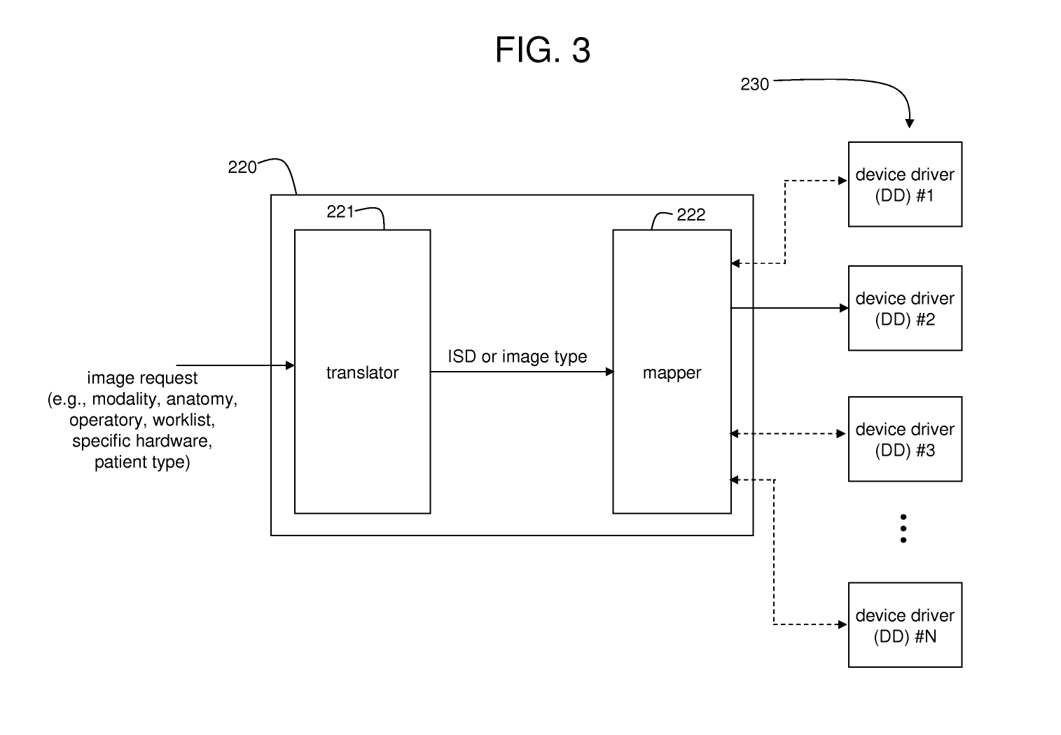

FIG. 3 illustrates a block diagram of a portion of the universal image capture manager software module architecture 120 of FIG. 2 showing an image request configuration of an image acquisition process. The T/M 220 is shown as having a translator portion 221 and a mapper portion 222. Referring to FIGS. 1-3, an image request message from the IUSA 110 is received by the translator 221 of the UICM 120 via the interface 210. The image request message may include various types of information such as, for example, an imaging modality, an anatomy, an operatory, a worklist, a specific hardware, or a patient type such as, for example, pediatric. Other types of image request information are possible as well, in accordance with various embodiments of the present invention.

The imaging modality may be, for example, an intra-oral X-ray modality, a pan-oral X-ray modality, an intra-oral visible light camera modality, or any other type of imaging modality associated with the system 100. The anatomy may be, for example, one or more teeth numbers, a full skull, or any other type of anatomy associated with the system 100. The operatory may be, for example, operatory #1, or operatory #4, a pan-oral operatory, an ultrasound operatory, or any other type of operatory associated with the system 100. The worklist may be a worklist from a PACS server where the worklist includes a patient name, for example. The specific hardware type may be, for example, a particular type of intra-oral sensor or a particular type of intra-oral camera. The patient type may be pediatric, geriatric, or adolescent, for example.

In all cases, the translator 221 is configured to translate the information in the image request message to an ISD type or an image type. In some cases, the translation may be trivial or may even be a pass through. For example, if a specific hardware type is specified in the image request message, the specific hardware type may be directly used as the ISD type. In other cases, the translation may be more complex. For example, if a patient type and an anatomy are specified in the image request message, the translator 221 may have to address a look-up-table within the translator 221 which translates a plurality of possible patient type/anatomy combinations to possible ISD types or image types.

Again, the translator 221 operates on the image request message to translate the image request message into an ISD type or an image type, in accordance with an embodiment of the present invention. The ISD type or the image type is sent to the mapper 222 which maps the ISD type or the image type to at least one of the plurality of device drivers (DDs) 230, in accordance with an embodiment of the present invention. Other methods of translating and mapping are possible as well, in accordance with various other embodiments of the present invention.

As an example, the IUSA 110 may send an image request message to the UICM 120 requesting an image or images associated with an intra-oral X-ray modality. The translator 221 translates the intra-oral X-ray modality within the image request message to an image type being that of an intra-oral X-ray image type. The mapper 222 maps the intra-oral X-ray image type received from the translator 221 to device driver (DD) #1, which is an image acquisition interface for ISD #1 which is a first intra-oral X-ray sensor, and to device driver (DD) #3, which is an image acquisition interface for ISD #3 which is a second intra-oral X-ray sensor. In this manner, the UICM 120 activates DD #1 and DD #3 to acquire intra-oral X-ray image data from ISD #1 and ISD #3, respectively.

As another example, the IUSA 110 may send an image request message to the UICM 120 requesting an image or images associated with operatory #3. The translator 221 translates the operatory #3 information within the image request message to two image source device (ISD) types that are known by the UICM 120 to be used in operatory #3. The mapper 222 maps the two image source device types from the translator to device driver (DD) #4 which is an image acquisition interface for ISD #4 and device driver (DD) #7 which is an image acquisition interface for ISD #7. In this manner, the UICM 120 activates DD #4 and DD #7 to acquire image data from ISD #4 and ISD #7, respectively.

In accordance with another embodiment of the present invention, the mapper 222 may identify one or more device drivers based on the ISD type or the image type from the translator 221. The identified device drivers may then be sent from the UICM 120 to the IUSA 110 and displayed to a user of the IUSA 110, allowing the user to select one or more of the displayed device drivers. In this way, a user can readily select an appropriate device driver(s) and initiate acquisition of the image data from that device driver(s).

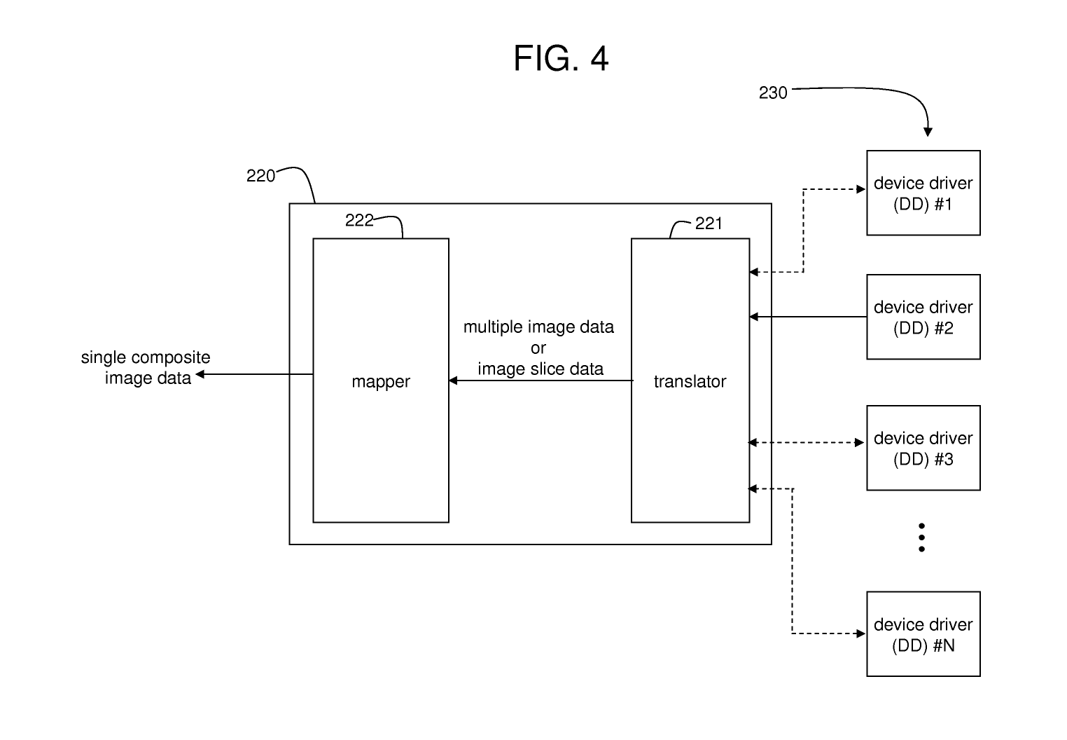

FIG. 4 illustrates a block diagram of a portion of the universal image capture manager software module architecture 120 of FIG. 2 showing an image return configuration of an image acquisition process. When a device driver (DD) of the UICM 120 communicates with an ISD in response to an image request message from the IUSA 110, the device driver (DD) returns image data from the ISD to the translator 221 of the UICM 120. The returned image data may be in the form of raw image data representing one or more images, or volumetric data (e.g., image slices in a single DICOM file or multiple DICOM files each having a single image slice).

The translator 221 receives the returned image data and transforms it, if necessary. For example, if the returned image data is volumetric data, the translator 221 may break up the volumetric data into data sets of single image slices, in accordance with an embodiment of the present invention. If the returned image data is combined raw image data of multiple images from multiple ISDs, the translator 221 may extract the image data for each individual image to form a plurality of individual image data sets.

The IUSA 110 may be expecting image data in the form of a single image, even if multiple images were acquired from one or more ISDs in response to an image request message. As a result, the mapper 222 receives the transformed image data from the translator 221 and maps the transformed image data into a single composite image. For example, a plurality of image slice data may be mapped into a layout as a single composite image by the mapper 222. As another example, multiple images from a single ISD may be mapped into a layout as a single composite image (e.g., a full mouth series of dental X-rays may be mapped into a layout as a single composite image). Furthermore, images from multiple ISDs may be mapped into a layout as a single composite image. The single composite image is then returned to the IUSA 110 via the interface 210. If the IUSA 110 is configured to receive multiple images in response to a request, then the UICM 120 may instead return multiple image data sets to the IUSA 110.

In accordance with an embodiment of the present invention, the interface 210 is configured to access the clipboard of the computer processing device 111 and paste the returned image data set to the clipboard. In accordance with another embodiment of the present invention, the UICM 120 may be configured to enable all of the plurality of device drivers (DDs) 230 upon receipt of an image request message and, if any ISD of the plurality of ISDs 130 has newly acquired image data to return, the newly acquired image data will be automatically returned to the IUSA 110 through the UICM 120 as previously described herein.

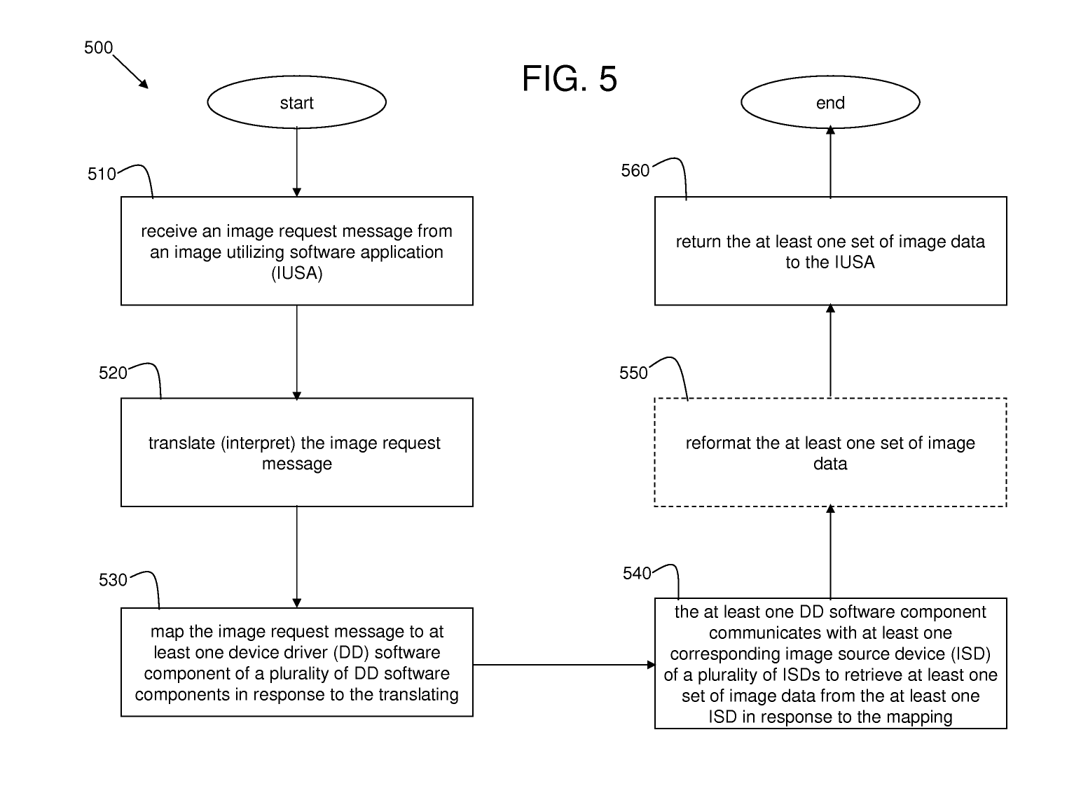

FIG. 5 is a flowchart of an embodiment of a method 500 for acquiring image data from any of multiple image source devices using the system 100 of FIG. 1. In step 510 of the method 500, an image request message is received from an image utilizing software application (IUSA). In step 520, the image request message is translated or interpreted. In step 530, the translated image request message is mapped to at least one device driver (DD) software component of a plurality of DD software components in response to the translating. In step 540, the at least one DD software component communicates with at least one corresponding image source device (ISD) of a plurality of ISDs to retrieve at least one set of image data from the at least one ISD in response to the mapping. In step 550, the at least one set of image data is reformatted. The reformatting may involve translating and mapping the acquired image data as described previously herein. In step 560, the at least one set of image data is returned to the IUSA. Step 550 is optional since it is possible for the original image data set acquired from the ISD to be provided to the IUSA unaltered.

As an example, the IUSA 110 may send an image request message to the UICM 120 where the image request message includes anatomy information indicating the brain. The UICM 120 translates the image request message to a computed tomography (CT) volumetric image type. The UICM 120 then maps the translated image request message (i.e., CT volumetric image type) to device driver #5. DD #5 is activated to communicate with ISD #5 which is a CT X-ray scanner that has recently been used to capture volumetric image data of a patient's brain. The volumetric image data is acquired from ISD #5 via DD #5 and the UICM 120 reformats the volumetric data (e.g., using the translating and mapping techniques previously described herein) into a single composite image of individual image slices. The single composite image data set is returned from the UICM 120 to the IUSA 110, fulfilling the image request.

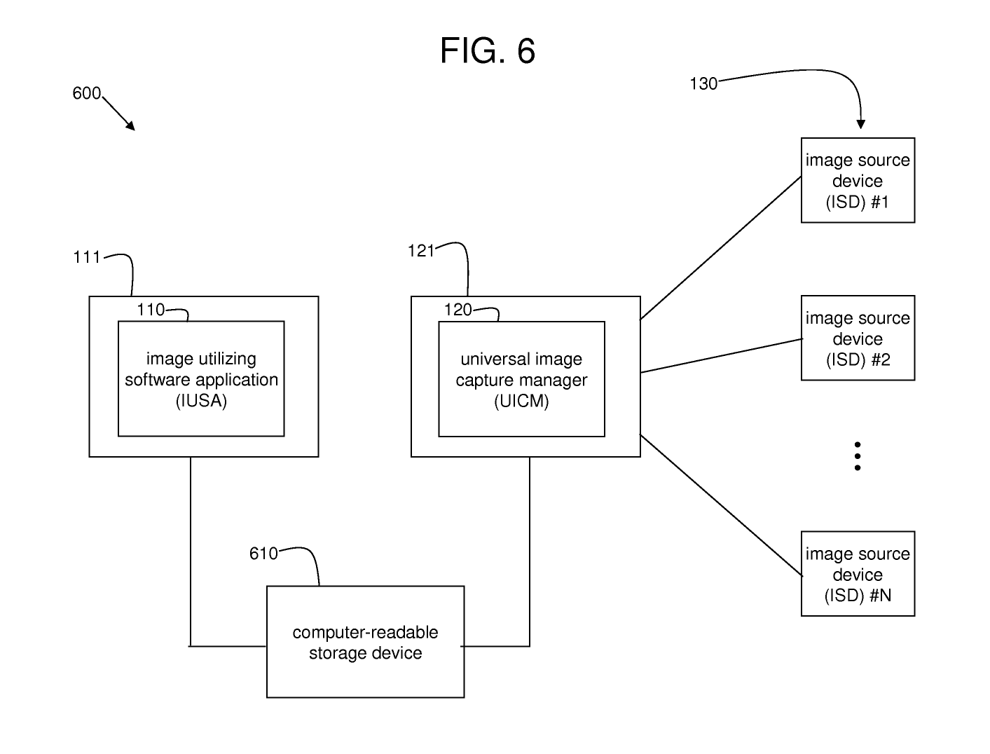

FIG. 6 illustrates a block diagram of a second example embodiment of a system 600 for acquiring image data from multiple sources. The system 600 includes an image utilizing software application (IUSA) 110 implemented on a first computer processing device 111, a universal image capture manager (UICM) 120 implemented on a second computer processing device 121, and a plurality of image source devices (ISDs) 130, similar to those elements of the system 100 of FIG. 1. However, the system 600 further includes a computer-readable storage device 610. The computer-readable storage device 610 may be a hard disk drive, for example, in accordance with an embodiment of the present invention. Other types of computer-readable storage devices are possible as well, in accordance with various embodiments of the present invention.

The UICM 120 operatively interfaces with the plurality of ISDs 130 as in FIG. 1. The computer-readable storage device 210 operatively interfaces between the IUSA 110 and the UICM 120, instead of the IUSA 110 and the UICM 120 communicating directly with each other. In accordance with an embodiment of the present invention, when the IUSA 110 requests image data, the IUSA 110 sends a file to the computer-readable storage device 610 having an image request message in the file. The UICM 120 periodically checks the computer-readable storage device 610 to determine if any new requests have been received from the IUSA 110.

When the UICM 120 determines that a new image request message has been stored on the computer-readable storage device 610 (e.g., by the IUSA 110), the UICM 120 reads the file from the computer-readable storage device 610 and proceeds to process the image request message, retrieve the corresponding image data from at least one of the plurality of ISDs 130, and store the image data on the computer-readable storage device 610 in a file that is associated with the original image request file from the IUSA 110.

The IUSA 110 periodically checks the computer-readable storage device 610 to determine if the requested image data has been stored to the computer-readable storage device 610 and, when found, proceeds to retrieve the image data from the computer-readable storage device 610. In this manner, the IUSA 110 and the UICM 120 are effectively asynchronously linked to each other through the computer-readable storage device 610. The IUSA 110 only has to be concerned with sending an image request file to the computer-readable storage device 610 and retrieving image data from the computer-readable storage device 610. Again, the IUSA 110 does not have to be concerned with being able to directly acquire image data from multiple different image data sources itself. Instead, the UICM 120 takes on the burden of communicating with the various ISDs 130 with their various communication interfaces and protocols.

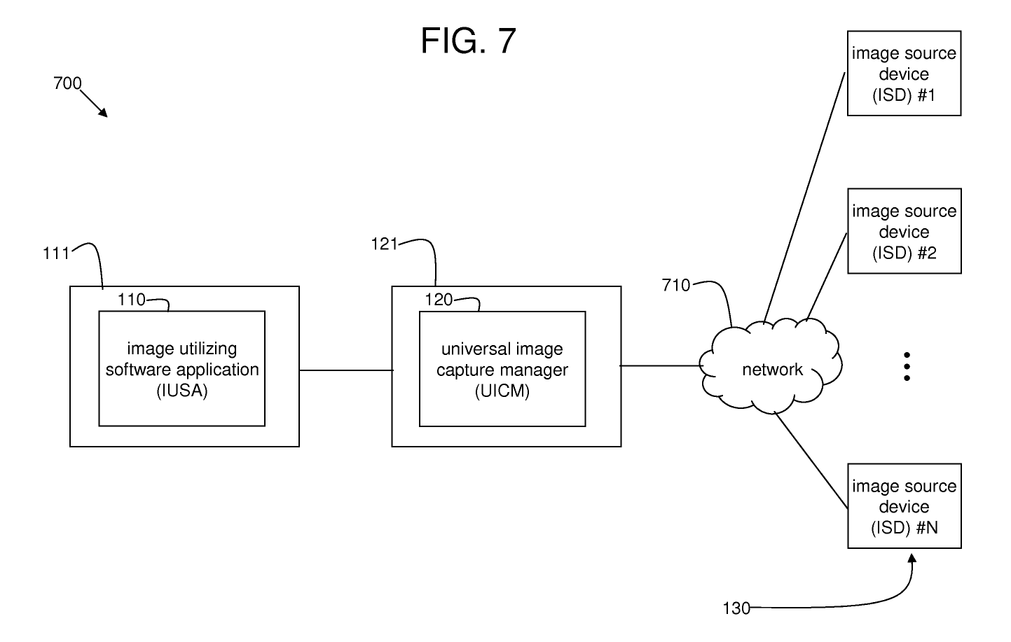

FIG. 7 illustrates a block diagram of a third example embodiment of a system 700 for acquiring image data from multiple sources. The system 700 is very similar to the system 100 of FIG. 1. However, the system 700 of FIG. 7 includes a network 710 communicatively interfacing between the UICM 120 and the plurality of ISDs 130. The network 710 may be, for example, a local-area-network (LAN), a wide-area-network (WAN), or the internet. The network 710 allows the plurality of ISDs 130 to be remotely located from the UICM 120 and the IUSA 110. As a result, the IUSA 110 is able to acquire image data from a plurality of ISDs 130 at a plurality of remote locations.

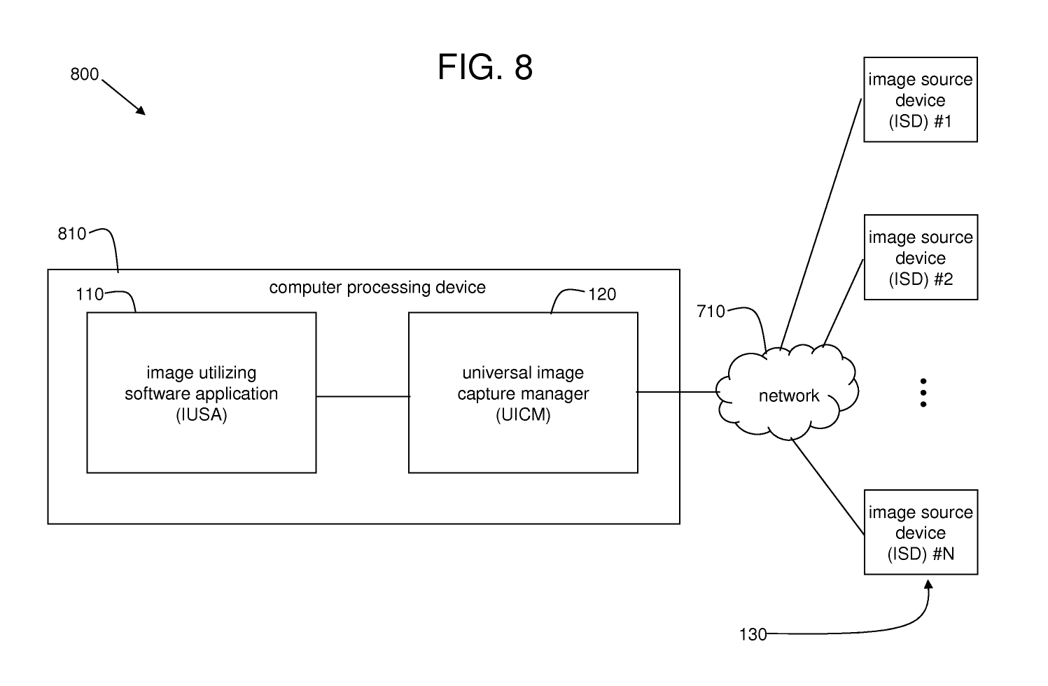

FIG. 8 illustrates a block diagram of a fourth example embodiment of a system 800 for acquiring image data from multiple sources. The system 800 is very similar to the system 700 of FIG. 7. However, in the system 800 of FIG. 8, the IUSA 110 and the UICM 120 are implemented on the same computer processing device 810. The IUSA 110 and the UICM 120 communicate with each other internally via the hardware architecture of the computer processing device 810. The UICM 120 communicates to the plurality of ISDs 130 via the network 710 through an interface port out of the computer processing device 810. In this manner, a separate computer device, which is separate from the computer device on which the IUSA is implemented, is not required to implement the UICM.

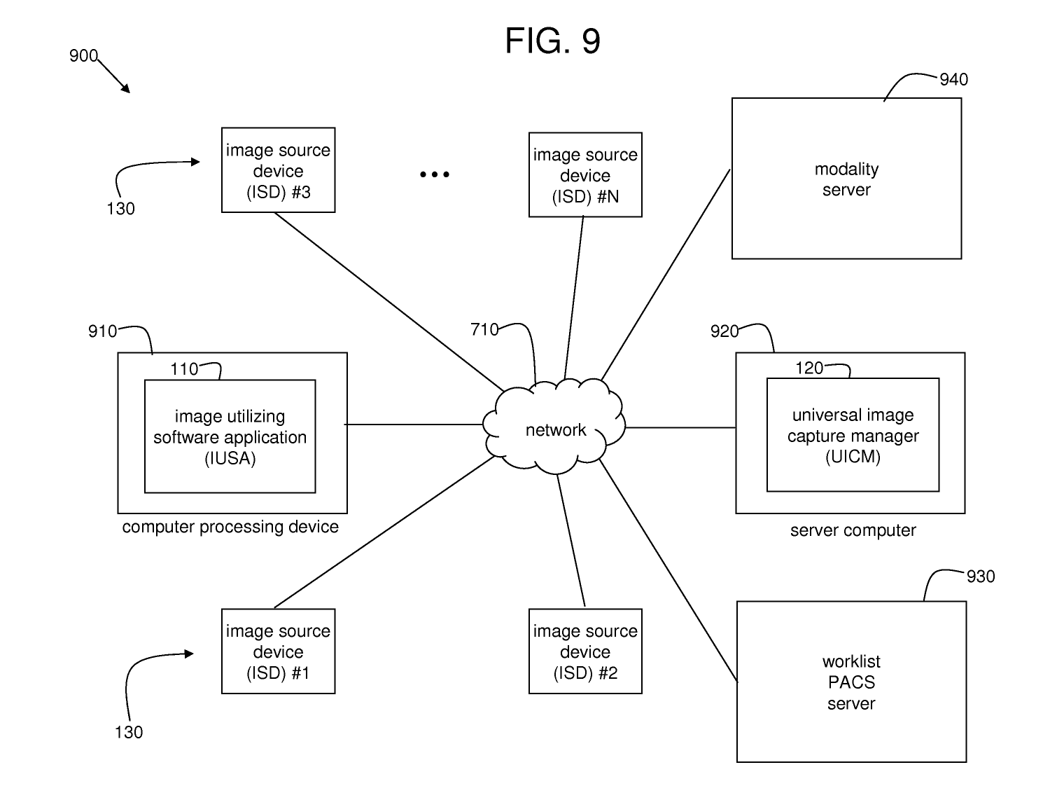

FIG. 9 illustrates a block diagram of a fifth example embodiment of a system 900 for acquiring image data from multiple sources. The system 900 includes an image utilizing software application (IUSA) 110 implemented on a computer processing device 910, a universal image capture manager (UICM) 120 implemented on a server computer 920, and a plurality of image source devices (ISDs) 130 (e.g., ISD #1 to ISD #N, where N represents a positive integer). The system 900 also includes a worklist PACS server 930 and a modality server 940. The system 900 further includes a network 710 allowing communication (e.g., remote communication) between the various elements 130 and 910-940.

The IUSA 110 and the UICM 120 communicate over the network 710. The UICM 120 and the ISDs 130 communicate over the network 710. Furthermore, the IUSA 110 may communicate with the worklist PACS server 930 and the modality server 940 over the network 710. For example, the IUSA 110 may bridge to the modality server 940 over the network to pull in information relating to ISD hardware to be invoked in response to an image request message. Information from the modality server 940 may be embedded in the image request message by the IUSA 110 before sending the image request message to the UICM 120. Alternatively, the UICM 120 may bridge to the modality server 940 in response to an image request message from the IUSA 110. The UICM 120 may use information obtained from the modality server 940 to help determine which ISD hardware to invoke to fulfill the image request (i.e., to acquire image data).

As another example, the IUSA 110 may bridge to the worklist PACS server 930 and retrieve a worklist via the network 710. The ISUA 110 may extract information from the worklist and embed that information in an image request message before sending the image request message to the UICM 120. Alternatively, the UICM 120 may bridge to the worklist PACS server 930 in response to an image request message from the IUSA 110. The UICM 120 may use information in the image request message to obtain a worklist from the worklist PACS server 930 and extract information from the worklist to help determine which ISD hardware to invoke to fulfill the image request.

In summary, a universal image capture manager (UICM) for facilitating the acquisition of image data from a plurality of image source devices (ISDs) to an image utilizing software application (IUSA), along with systems, methods, and computer-readable media related therewith, are disclosed. The UICM is implemented on a computer processing device and includes a first software communication interface configured to facilitate data communication between the UICM and an IUSA. The UICM also includes a translator/mapper (T/M) software component being in operative communication with the first software communication interface and configured to translate and map an image request from an IUSA to at least one device driver (DD) software component of a plurality of DD software components. The UICM further includes a plurality of DD software components being in operative communication with the T/M software component. Each of the DD software components is configured to facilitate data communication with at least one ISD.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiment disclosed, but that the claimed subject matter will include all embodiments falling within the scope of the appended claims.

What is claimed is:

1. A universal image capture manager (UICM) for facilitating the acquisition of image data from a plurality of image source devices (ISDs) to an image utilizing software application (IUSA), said UICM comprising:
a computer processing device;
a first software communication interface implemented on said computer processing device and configured to facilitate data communication between said universal image capture manager (UICM) and an image utilizing software application (IUSA);
a translator/mapper (T/M) software component implemented on said computer processing device, being in operative communication with said first software communication interface, and configured to translate and map an image request from an IUSA to at least one device driver (DD) software component of a plurality of device driver software components; and
a plurality of device driver (DD) software components implemented on said computer processing device, being in operative communication with said T/M software component, wherein each of said plurality of DD software components is configured to facilitate data communication with at least one image source device (ISD).

2. The universal image capture manager (UICM) of claim 1 wherein at least one of said plurality of device driver (DD) software components is a TWAIN-compatible device driver provided by a manufacturer of at least one image source device (ISD).

3. The universal image capture manager (UICM) of claim 1 wherein at least one of said plurality of device driver (DD) software components is a non-TWAIN-compatible direct driver interface developed using a software development kit (SDK) provided by a manufacturer of at least one image source device (ISD).

4. The universal image capture manager (UICM) of claim 1 wherein at least one of said plurality of device driver (DD) software components is a non-TWAIN-compatible direct driver interface.

5. The universal image capture manager (UICM) of claim 1 wherein at least one of said plurality of device driver (DD) software components is an application program interface (API).

6. The universal image capture manager (UICM) of claim 1 wherein at least one of said plurality of device driver (DD) software components is part of a dynamic link library (DLL).

7. The universal image capture manager (UICM) of claim 1 wherein said computer processing device includes one of a personal computer, a work station computer, and a server computer.

8. The universal image capture manager (UICM) of claim 1 wherein an image utilizing software application (IUSA), capable of communicating with said UICM via said first software communication interface, is implemented on said computer processing device.

9. The universal image capture manager (UICM) of claim 1 wherein said UICM is configured to be able to add a device driver (DD) software component to said plurality of device driver (DD) software components.

10. The universal image capture manager (UICM) of claim 1 wherein said UICM is configured to be able to remove a device driver (DD) software component from said plurality of device driver (DD) software components.

11. The universal image capture manager (UICM) of claim 1 wherein said first software communication interface is configured to facilitate data communication between said universal image capture manager (UICM) and an image utilizing software application (IUSA) through a computer network.

12. The universal image capture manager (UICM) of claim 1 wherein said first software communication interface is configured to facilitate data communication between said universal image capture manager (UICM) and an image utilizing software application (IUSA) through a computer-readable storage device.

13. The universal image capture manager (UICM) of claim 1 wherein each of said plurality of DD software components is configured to facilitate data communication with at least one image source device (ISD) through a computer network.

14. The universal image capture manager (UICM) of claim 1 wherein said translator/mapper (T/M) software component is further configured to translate and map image data received from at least one image source device (ISD) via at least one device driver (DD).

15. A method of acquiring image data from any of multiple image source devices, said method comprising:
receiving an image request message from an image utilizing software application (IUSA);
translating said image request message;
mapping said image request message to at least one device driver (DD) software component of a plurality of device driver (DD) software components in response to said translating;
said at least one device driver (DD) software component communicating with at least one corresponding image source device (ISD) of a plurality of image source devices to retrieve at least one set of image data from said at least one image source device (ISD) in response to said mapping; and
returning said at least one set of image data to said image utilizing software application (IUSA).

16. The method of claim 15 further comprising reformatting said at least one set of image data before returning said at least one set of image data to said image utilizing software application (IUSA).

17. The method of claim 15 wherein said method step of receiving an image request message is via at least one computer network.

18. The method of claim 15 wherein said method step of communicating with at least one image source device (ISD) is via at least one computer network.

19. The method of claim 15 wherein said method step of returning said at least one set of image data is via at least one computer network.

20. The method of claim 15 wherein said method step of returning said at least one set of image data is via a computer-readable storage device.

21. The method of claim 15 wherein said at least one device driver (DD) software component is a TWAIN-compatible device driver provided by a manufacturer of at least one image source device (ISD).

22. The method of claim 15 wherein said at least one device driver (DD) software component is a non-TWAIN-compatible direct driver interface developed using a software development kit (SDK) provided by a manufacturer of at least one image source device (ISD).

23. The method of claim 15 wherein said at least one device driver (DD) software component is a non-TWAIN-compatible direct driver interface.

24. The method of claim 15 wherein said at least one device driver (DD) software component is an application program interface (API).

25. The method of claim 15 wherein said at least one device driver (DD) software component is part of a dynamic link library (DLL).

26. The method of claim 15 wherein said method is implemented on a computer processing device.

27. The method of claim 16 wherein said method step of reformatting said at least one set of image data includes mapping said at least one set of image data, representative of multiple images, into a single composite image.

28. The method of claim 16 wherein said method step of reformatting said at least one set of image data includes mapping said at least one set of image data, representative of multiple images from multiple image source devices, into a single composite image.

29. The method of claim 16 wherein said method step of reformatting said at least one set of image data includes mapping said at least one set of image data, representative of multiple image slices from a single image source device, into a single composite image.

30. A non-transitory computer-readable medium having a plurality of computer-executable instructions thereon for performing a method comprising:
receiving an image request message from an image utilizing software application (IUSA);
translating said image request message;
mapping said image request message to at least one device driver (DD) software component of a plurality of device driver (DD) software components in response to said translating;
said at least one device driver (DD) software component communicating with at least one corresponding image source device (ISD) of a plurality of image source devices to retrieve at least one set of image data from said at least one image source device (ISD) in response to said mapping; and
returning said at least one set of image data to said image utilizing software application (IUSA).

31. The non-transitory computer-readable medium of claim 30 wherein said method further comprises reformatting said at least one set of image data before returning said at least one set of image data to said image utilizing software application (IUSA).

32. A system for acquiring image data from multiple sources, said system comprising:
an image utilizing software application (IUSA) implemented on a computer processing device;
a plurality of image source devices (ISDs); and
a universal image capture manager (UICM) configured to operatively communicate with said image utilizing software application (IUSA) and said plurality of image source devices to retrieve image data from at least one of said plurality of image source devices (ISDs) in response to a request from said image utilizing software application (IUSA).

33. The system of claim 32 wherein said universal image capture manager (UICM) is a software module implemented on said computer processing device on which said image utilizing software application (IUSA) is implemented.

34. The system of claim 32 wherein said universal image capture manager (UICM) is a software module implemented on a computer processing device that is different from said computer processing device on which said image utilizing software application (IUSA) is implemented.

35. The system of claim 32 further comprising a computer network operatively interfacing between said universal image capture manager (UICM) and said plurality of image source devices (ISDs).

36. The system of claim 32 further comprising a computer network operatively interfacing between said image utilizing software application (IUSA) and said universal image capture manager (UICM).

37. The system of claim 32 further comprising a computer network operatively interfacing between said image utilizing software application (IUSA), said universal image capture manager (UICM), and said plurality of image source devices (ISDs).

38. The system of claim 32 further comprising a modality server operatively interfacing to said image utilizing software application (IUSA) via a computer network.

39. The system of claim 32 further comprising a worklist PACS server operatively interfacing to said image utilizing software application (IUSA) via a computer network.

40. An apparatus for acquiring image data from any of multiple image source devices, said apparatus comprising:
means for receiving an image request message from an image utilizing software application (IUSA);
means for translating said image request message;
means for mapping said image request message to at least one image source device (ISD) of a plurality of image source devices in response to said translating;
means for communicating with said at least one image source device (ISD) to retrieve at least one set of image data from said at least one image source device (ISD) in response to said mapping; and
means for returning said at least one set of image data to said image utilizing software application (IUSA).
